(19) United States
(12) Patent Application Publication
(10) Pub. No.: US 2011/0244000 A1
(43) Pub. Date: Oct. 6, 2011

(54) ANTIMICROBIAL FILM LAMINATE ASSEMBLIES AND METHODS OF USING AND MANUFACTURING THE SAME

(76) Inventors: Lawrence Woodcock Gorin, Louisville, KY (US); John David Haywood, New Albany, IN (US); Robert Douglas Hamilton, Hanover, IN (US)

(21) Appl. No.: 13/079,917

(22) Filed: Apr. 5, 2011

Related U.S. Application Data
(60) Provisional application No. 61/321,234, filed on Apr. 6, 2010.

(51) Int. Cl. A01N 25/34; A01P 1/00; A01N 59/16; B32B 37/26

(52) U.S. Cl. 424/400; 424/618; 156/249

(57) ABSTRACT

An antimicrobial film laminate assembly is disclosed. The assembly includes an antimicrobial film laminate having a first surface at least partially coated with an adhesive and an opposing second surface, the antimicrobial film laminate includes at least one antimicrobial compound, and a unitary backing positioned upon the first surface of the antimicrobial film laminate.

### PRIORITY

The present Nonprovisional Patent Application claims the priority benefit of U.S. Provisional Patent Application Ser. No. 61/321,234, filed Apr. 06, 2010, the contents of which is hereby incorporated by reference in its entirety into this disclosure.

### BRIEF SUMMARY

The disclosure of the present application discloses various antimicrobial film laminate assemblies and methods of using and manufacturing the same. The various antimicrobial film laminate assemblies of the present disclosure may be custom-configured (die-cut) in such a way to correspond with the size and shape of various targeted surfaces, such as walls, floors, tables, and various objects desired to be coated, such as in hospitals, restaurants, and restrooms, for example.

In at least one embodiment of an antimicrobial film laminate assembly of the present disclosure, the assembly comprises an antimicrobial film laminate having a first surface at least partially coated with an adhesive and an opposing second surface, said antimicrobial film laminate comprising at least one antimicrobial compound, and a unitary backing positioned upon the first surface of the antimicrobial film laminate. In another embodiment, the antimicrobial film laminate assembly comprises at least one tab. In yet another embodiment, the unitary backing is cut to form at least one placement strip and at least one main strip, and wherein the at least one tab is positioned at the at least one placement strip. In an additional embodiment, the at least one tab comprises two tabs. In another embodiment, the two tabs are configured about the antimicrobial film laminate assembly at or near relative ends of the antimicrobial film laminate assembly. In yet another embodiment, the two tabs are configured about the antimicrobial film laminate assembly at or near the relative middle of the antimicrobial film laminate assembly.

In at least one embodiment of an antimicrobial film laminate assembly of the present disclosure, the adhesive is deadened at the at least one tab. In an additional embodiment, no adhesive is present upon the first surface at the at least one tab.

In at least one embodiment of an antimicrobial film laminate assembly of the present disclosure, the unitary backing is cut to form at least one placement strip and at least one main strip. In another embodiment, the at least one placement strip comprises one placement strip. In yet another embodiment, the at least one placement strip comprises two or more placement strips. In an additional embodiment, the at least one main strip comprises one main strip. In yet an additional embodiment, the at least one main strip comprises two or more main strips. In another embodiment, the at least one placement strip comprises one placement strip, and the at least one main strip comprises one main strip. In various embodiments, the at least one placement strip comprises one placement strip, and the at least one main strip comprises two main strips.

In at least one embodiment of an antimicrobial film laminate assembly of the present disclosure, the adhesive is capable of causing the antimicrobial film laminate to either permanently or removably adhere to one or more targeted surfaces. In an additional embodiment, the at least one antimicrobial compound comprises a silver ion antimicrobial compound. In yet an additional embodiment, the antimicrobial film laminate is placed onto a roll or is rolled into a rolled configuration. In another embodiment, at least part of the antimicrobial film laminate assembly has indicia and/or a color imprinted thereon.

In at least one embodiment of an antimicrobial film laminate assembly of the present disclosure, a user can write on the antimicrobial film laminate using a dry erase marker, and whereby said writings can be removed using an eraser. In another embodiment, the antimicrobial film laminate is made from a material selected from the group consisting of polyethylene terephthalate, polypropylene, high impact polystyrene, polyvinyl chloride, and paper. In yet another embodiment, the antimicrobial film laminate is selected from the group consisting of a transparent antimicrobial film laminate, a translucent antimicrobial film laminate, and an opaque antimicrobial film laminate.

In at least one embodiment of an antimicrobial film laminate assembly of the present disclosure, the assembly comprises an antimicrobial film laminate having a first surface at least partially coated with an adhesive and an opposing second surface, said antimicrobial film laminate comprising at least one antimicrobial compound, at least one placement strip positioned upon the first surface of the antimicrobial film laminate at or near at least one tab, the at least one placement strip covering at least part of the adhesive, and at least one main strip positioned upon the first surface of the antimicrobial film laminate, the main strip also covering at least part of the adhesive, wherein the adhesive is either deadened or not present upon the antimicrobial film laminate at the at least one tab.

In at least one embodiment of a method for affixing an antimicrobial film laminate to a targeted surface of the present disclosure, the method comprises the steps of removing a placement strip from an antimicrobial film laminate to expose an adhesive surface, aligning the antimicrobial film laminate with a targeted surface, and applying a force to an opposite side of the antimicrobial film laminate so that the adhesive surface of the antimicrobial film laminate is affixed to the targeted surface where the placement strip has been removed. In another embodiment, the method further comprises the steps of removing a first main strip from the antimicrobial film laminate to expose more adhesive surface, and applying a force to an opposite side of the antimicrobial film laminate so that the adhesive surface of the antimicrobial film laminate where the first main strip has been removed is affixed to the targeted surface. In yet another embodiment, the method further comprises the steps of repeating one or more of the aforementioned steps with a second antimicrobial film laminate, wherein the second antimicrobial film laminate is affixed upon the original antimicrobial film laminate.

In at least one embodiment of a method for affixing an antimicrobial film laminate to a targeted surface of the present disclosure, the method further comprises the steps of removing a second main strip from the antimicrobial film laminate to expose more adhesive surface, and applying a force to an opposite side of the antimicrobial film laminate so that the adhesive surface of the antimicrobial film laminate where the second main strip has been removed is affixed to the targeted surface. In another embodiment, the method further comprises the step of repeating one or more of the aforementioned steps with a second antimicrobial film laminate, wherein the second antimicrobial film laminate is affixed upon the original antimicrobial film laminate.

In at least one embodiment of a method for manufacturing an antimicrobial film laminate assembly of the present disclosure, the method comprises the steps of impregnating and/or coating a laminate with an antimicrobial compound, applying an adhesive to a first surface of the laminate, and placing at least one backing strip over the first surface of the laminate. In another embodiment, the method further comprises the step of cutting the at least one backing strip to form at least one placement strip and at least one main strip. In yet another embodiment, the method further comprises the step of cutting the antimicrobial film laminate assembly to a desired shape. In an additional embodiment, the method further comprises the step of further comprising the step of placing the antimicrobial film laminate assembly onto a roll. In another embodiment, the method further comprises the step of rolling the antimicrobial film laminate assembly into a rolled configuration. In yet another embodiment, the method further comprises the steps of cutting the antimicrobial film laminate assembly to a desired shape, and placing the antimicrobial film laminate assembly onto a roll.

In at least one embodiment of a method for manufacturing an antimicrobial film laminate assembly of the present disclosure, the method comprises the steps of impregnating and/or coating a laminate with an antimicrobial compound, applying an adhesive to a first surface of the laminate, and either (a) removing at least part of the adhesive from the first surface of the laminate, or (b) deadening at least part of the adhesive from the first surface of the laminate. In another embodiment, the method comprises the step of removing at least part of the adhesive, and wherein said step is performed by physically removing the adhesive using a scraping device. In an additional embodiment, the method comprises the step of removing at least part of the adhesive, and wherein said step is performed by removing the adhesive using one or more chemicals capable of removing adhesive. In another embodiment, the method comprises the step of deadening at least part of the adhesive, and wherein said step is performed by deadening the adhesive using ultraviolet light.

In at least one embodiment of a method for manufacturing an antimicrobial film laminate assembly of the present disclosure, the method comprises the step of deadening at least part of the adhesive, and wherein said step is performed by deadening the adhesive using one or more chemicals capable of deadening adhesive to minimize or eliminate adhesive tack. In another embodiment, the steps of removing or deadening at least part of the adhesive are performed at one or more tabs of the antimicrobial film laminate assembly.

In at least one embodiment of a method for manufacturing an antimicrobial film laminate assembly of the present disclosure, the method further comprises the step of applying an indicia and/or a color to at least part of antimicrobial film laminate assembly. In another embodiment, the step of applying an indicia and/or a color is performed by applying an indicia and/or a color to the first surface of the laminate. In yet another embodiment, the step of applying an indicia and/or a color is performed using flexographic printing. In an additional embodiment, the steps of removing or deadening at least part of the adhesive are performed at a location of the first surface of the laminate that will have the indicia and/or the color applied thereto.

In at least one embodiment of a method for manufacturing an antimicrobial film laminate assembly of the present disclosure, the method further comprises the step of placing at least one backing strip over the first surface of the laminate. In another embodiment, the method further comprises the step of cutting the at least one backing strip to form at least one placement strip and at least one main strip. In yet another embodiment, the method further comprises the step of cutting the antimicrobial film laminate assembly to a desired shape.

In at least one embodiment of a method for manufacturing an antimicrobial film laminate assembly of the present disclosure, the method comprising the steps of delaminating an antimicrobial film laminate assembly, and either (a) removing at least part of the adhesive from the first surface of the laminate, or (b) deadening at least part of the adhesive from the first surface of the laminate. In an additional embodiment, the step of delaminating an antimicrobial film laminate assembly is performed by removing a unitary backing from an antimicrobial film laminate of the antimicrobial film laminate assembly. In another embodiment, the method further comprises the step of applying an indicia and/or a color to at least part of antimicrobial film laminate assembly.

In at least one embodiment of a method for manufacturing an antimicrobial film laminate assembly of the present disclosure, the step of applying an indicia and/or a color is performed by applying an indicia and/or a color to the first surface of the laminate. In various embodiments, the steps of removing or deadening at least part of the adhesive are performed at a location of the first surface of the laminate that will have the indicia and/or the color applied thereto. In another embodiment, the steps of removing or deadening at least part of the adhesive are performed at one or more tabs of the antimicrobial film laminate assembly. In yet another embodiment, the step of deadening at least part of the adhesive is performed by printing a deadener on the adhesive.

In at least one embodiment of a method for manufacturing an antimicrobial film laminate assembly of the present disclosure, the method further comprises the step of relaminating the antimicrobial film laminate assembly. In another embodiment, the step of relaminating the antimicrobial film laminate assembly is performed by reintroducing a unitary backing to an antimicrobial film laminate of the antimicrobial film laminate assembly. In another embodiment, the method further comprises the step of cutting the unitary backing to form at least one placement strip and at least one main strip. In yet another embodiment, the method further comprises the step of cutting the antimicrobial film laminate assembly to a desired shape.

In at least one embodiment of an antimicrobial film laminate assembly of the present disclosure, the assembly comprises an antimicrobial film laminate having a first surface and an opposing second surface, said antimicrobial film laminate comprising at least one antimicrobial compound, and a unitary backing positioned upon the first surface of the antimicrobial film laminate. In another embodiment, the antimicrobial film laminate is capable of adhering to a targeted surface by way of static cling.

### BRIEF DESCRIPTION OF THE DRAWINGS

FIG. 1A shows an exemplary embodiment of an antimicrobial film laminate assembly comprising an antimicrobial film laminate and a placement strip and a main strip affixed thereto, according to at least one embodiment of the present disclosure;

FIG. 1B shows a view of at least part of the antimicrobial film laminate assembly shown in FIG. 1A, according to at least one embodiment of the present disclosure;

FIG. 1C shows an antimicrobial film laminate assembly comprising an antimicrobial film laminate and a unitary backing present thereon, according to at least one embodiment of the present disclosure;

FIG. 2A shows a view of the antimicrobial film laminate assembly shown in FIG. 1A with the placement strip and the main strip removed from the antimicrobial film laminate, according to at least one embodiment of the present disclosure;

FIG. 2B shows a view of the opposite side of the antimicrobial film laminate shown in FIG. 1A so that the antimicrobial surface is shown, according to at least one embodiment of the present disclosure;

FIG. 3 shows steps of an exemplary method of affixing an exemplary antimicrobial film laminate to a targeted surface, according to at least one embodiment of the present disclosure;

FIG. 4A shows an exemplary embodiment of an antimicrobial film laminate assembly comprising an antimicrobial film having a placement strip and two main strips affixed thereto, according to at least one embodiment of the present disclosure;

FIG. 4B shows a view of at least part of the antimicrobial film laminate assembly shown in FIG. 4A, according to at least one embodiment of the present disclosure;

FIG. 5A shows a view of the antimicrobial film laminate assembly shown in FIG. 4A with the placement strip and the main strips removed from the antimicrobial film laminate, according to at least one embodiment of the present disclosure;

FIG. 5B shows a view of the opposite side of the antimicrobial film laminate shown in FIG. 5A so that the antimicrobial surface is shown, according to at least one embodiment of the present disclosure;

FIG. 6 shows steps of an additional exemplary method of affixing an exemplary antimicrobial film laminate to a targeted surface, according to at least one embodiment of the present disclosure;

FIG. 7A shows another exemplary embodiment of an antimicrobial film laminate assembly comprising an antimicrobial film laminate and a placement strip and a main strip affixed thereto, according to at least one embodiment of the present disclosure;

FIG. 7B shows a view of at least part of the antimicrobial film laminate assembly shown in FIG. 7A, according to at least one embodiment of the present disclosure;

FIG. 8A shows a view of the antimicrobial film laminate assembly shown in FIG. 7A with the placement strip and the main strip removed from the antimicrobial film, according to at least one embodiment of the present disclosure;

FIG. 8B shows a view of the opposite side of the antimicrobial film laminate shown in FIG. 7A so that the antimicrobial surface is shown, according to at least one embodiment of the present disclosure;

FIG. 8C shows a side view of several antimicrobial film laminates stacked about one another upon a targeted surface, according to at least one embodiment of the present disclosure;

FIG. 9A shows an additional exemplary embodiment of an antimicrobial film laminate assembly having a placement strip and a main strip affixed to an antimicrobial film laminate, according to at least one embodiment of the present disclosure;

FIG. 9B shows a view of at least part of the antimicrobial film laminate assembly shown in FIG. 9A, according to at least one embodiment of the present disclosure;

FIG. 10A shows a view of the antimicrobial film laminate assembly shown in FIG. 9A with the placement strip and the main strip removed from the antimicrobial film laminate, according to at least one embodiment of the present disclosure;

FIG. 10B shows a view of the opposite side of the antimicrobial film laminate shown in FIG. 9A so that the antimicrobial surface is shown, according to at least one embodiment of the present disclosure; and

FIGS. 11-13 shows steps of exemplary methods for manufacturing an exemplary antimicrobial film laminate assembly, according to various embodiments of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

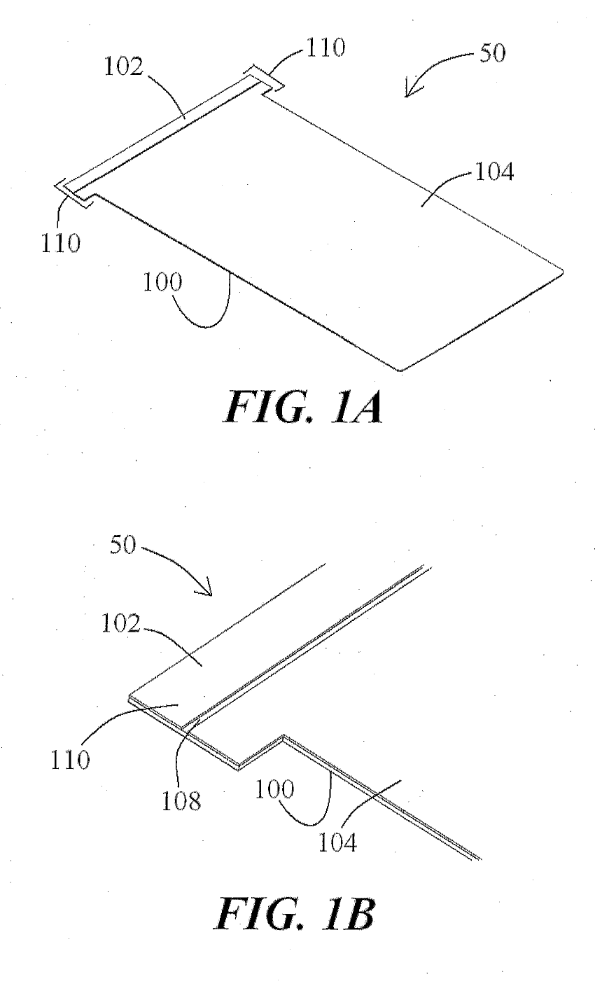

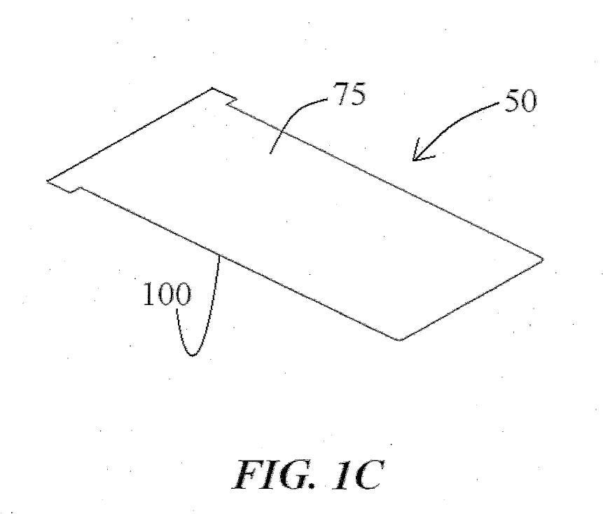

An exemplary embodiment of an antimicrobial film laminate assembly of the present disclosure is shown in FIGS. 1A and 1B. As shown in FIGS. 1A and 1B, an exemplary antimicrobial film laminate assembly 50 of the present disclosure comprises an antimicrobial film laminate 100 and at least one placement strip 102 and at least one main strip 104 positioned thereon. Placement strip 102 and main strip 104 may comprise any number of compositions suitable for removable adherence to an antimicrobial film laminate 100 of the present disclosure, including, but not limited to, plastic film, paper (which may be coated with wax or one or more polymers, for example), and the like.

Placement strip 102 and main strip 104 of the present disclosure, as described in further detail herein, may initially comprise a unitary backing strip which is then, for example, kerf cut or kiss cut to form placement strip 102 and main strip 104. As referenced herein, kerf cutting and/or kiss cutting refer to cutting through a portion of an antimicrobial film laminate assembly, such as, for example, cutting through a unitary backing 75 (referenced below) to form a placement strip 102 and a main strip 104, which is referenced by way of example and is not intended to limit the scope of the present disclosure. By way of example, FIG. 1C shows an exemplary embodiment of an antimicrobial film laminate assembly 50 of the present disclosure, whereby antimicrobial film laminate assembly 50 comprises an antimicrobial film laminate 100 and a unitary backing 75 positioned thereon. Kerf cutting unitary backing 75, for example, would divide unitary backing 75 into placement strip 102 and main strip 104 by way of cut 108 as shown in FIGS. 1A and 1B.

Antimicrobial film laminate 100, for example, may also comprise any number of plastics, polymers, fabrics, and/or other materials suitable for covering at least part of a targeted surface and capable of having one or more antimicrobial chemicals/compounds embedded therein and/or coated therewith. In various embodiments, antimicrobial film laminate 100 comprises polyethylene terephthalate (PET), polypropylene (PP), high impact polystyrene (HIPS), polyvinyl chloride (PVC), and/or paper. Various antimicrobial film laminates 100 of the present disclosure may be clear (transparent), translucent, opaque, and/or printed with various indicia thereon as referenced herein. In addition, an exemplary antimicrobial film laminate 100 of the present disclosure allows a user to write on .the antimicrobial film laminate 100 using a dry erase marker, whereby said writings may be removed using, for example, an eraser. Furthermore, various embodiments of antimicrobial film laminate assemblies 50 and/or antimicrobial film laminates 100 of the present disclosure may have indicia and/or colors imprinted/infused thereon, as described in further detail herein.

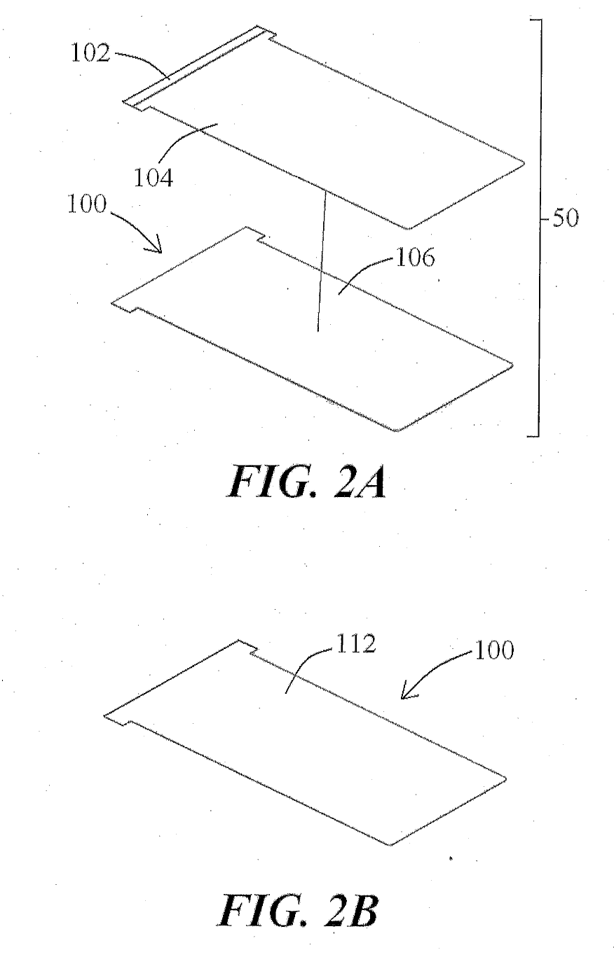

Placement strip 102 and main strip 104, when removed from antimicrobial film laminate 100, would expose an adhesive surface 106 coated on antimicrobial film laminate 100 as shown in FIGS. 2A and 2B. Adhesive surface 106 of antimicrobial film laminate 100 would have some sort of adhesive (not shown in FIGS. 2A and 2B) placed thereon so that adhesive surface 106 of antimicrobial film laminate 100 may either permanently or removably adhere to one or more targeted surfaces. In at least one embodiment, the adhesive would only cause an antimicrobial film laminate 100 to adhere to a targeted surface upon initial application, and would not cause antimicrobial film laminate 100 to adhere after it is peeled away.

An exemplary antimicrobial film laminate assembly 50 of the present disclosure may be sized and shaped in a way to permit antimicrobial film laminate 100 to be affixed to a desired targeted surface. For example, and as shown in FIGS. 1A and 1B, antimicrobial film laminate assembly 50 comprises an overall “t-shape”, whereby placement strip 102 is present at the “T” portion of antimicrobial film laminate assembly 50. As shown in FIG. 1A, such an exemplary embodiment of antimicrobial film laminate assembly 50 of the present disclosure comprises two tabs 110 to facilitate placement and/or alignment of antimicrobial film laminate 100 upon a targeted surface. Said tabs 110, in at least one embodiment and as shown in FIGS. 1A and 1B, are present near a relative end of antimicrobial film laminate assembly 50. In at least one embodiment, and as described in further detail herein, at least part of adhesive surface 106 would either (a) not have adhesive at one or more tabs 110, or (b) would have initially had an adhesive thereon, but that the adhesive would have either been removed or deadened at one or more tabs 110 to facilitate removal of unitary backing 75, placement strip 102, and/or main strip 104 from antimicrobial film laminate 100.

FIGS. 2A and 2B show an exemplary embodiment of an antimicrobial film laminate assembly 50 of the present disclosure with placement strip 102 and main strip 104 removed from antimicrobial film laminate 100 and an antimicrobial surface 112 of antimicrobial film laminate 100, respectively. As shown in FIG. 2A, placement strip 102 and main strip 104 are removed from antimicrobial film laminate 100 to expose adhesive surface 106 of said laminate 100. FIG. 2B shows the opposite side of an exemplary antimicrobial film laminate 100, whereby antimicrobial surface 112 of said laminate 100 is visible in the figure.

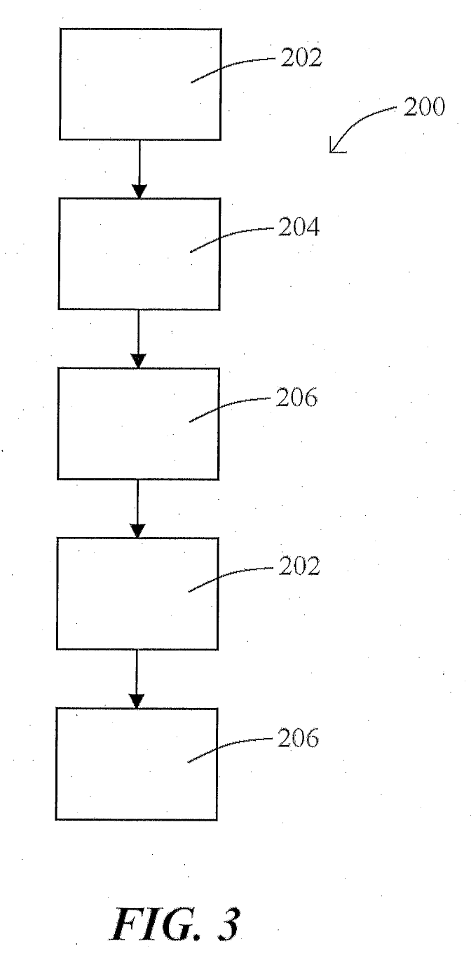

At least one embodiment of an antimicrobial film laminate 100 of an antimicrobial film laminate assembly 50 of the present disclosure may be affixed to a targeted surface as shown in the method steps shown in FIG. 3. As shown in FIG. 3, an exemplary method 200 of placing an antimicrobial film laminate 100 of the present disclosure upon a targeted surface comprises the steps of removing at least one of the at least one placement strips 102 from antimicrobial film. laminate 100 (an exemplary placement strip removal step 202), aligning the now-exposed adhesive surface 106 of antimicrobial film laminate 100 (which was previously covered by placement strip 102) with a targeted surface (an exemplary alignment step 204), and applying a force to the opposite side of antimicrobial film laminate 100 where adhesive surface 106 is exposed on the other side to affix antimicrobial film laminate 100 to the targeted surface (an exemplary adhesion step 206). In at least one additional method 200 of the present disclosure, and as shown in FIG. 3, method 200 may further comprise the steps of removing at least one of the at least one main strips 104 from antimicrobial film laminate 100 (also an exemplary placement strip removal step 202), and applying a force to the opposite side of antimicrobial film laminate 100 where adhesive surface 106 is exposed from the removal of main strip 104 on the other side to affix antimicrobial film laminate 100 to the targeted surface (also an exemplary adhesion step 206).

An exemplary antimicrobial film laminate 100 of the present disclosure may comprise any number of chemicals/compounds having antimicrobial properties suitable for such an application. For example, an exemplary antimicrobial film laminate 100 of the present disclosure may be impregnated with a silver ion antimicrobial compound which is either capable of killing various types of microbes such as bacteria, preventing the growth of various types of microbes such as bacteria, or otherwise rendering the microbes effectively harmless.

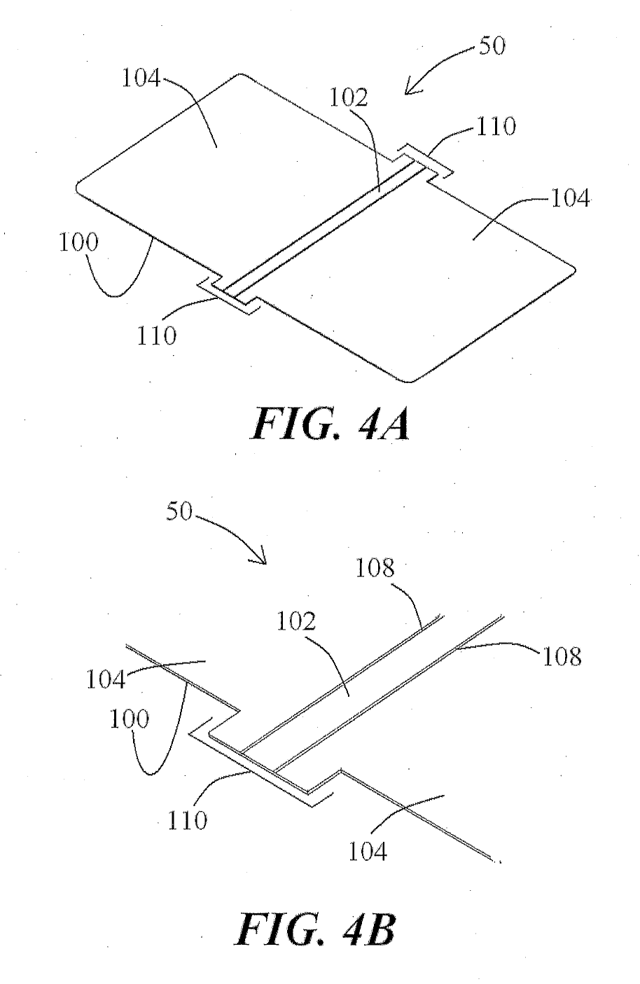

An additional embodiment of an antimicrobial film laminate assembly 50 of the present disclosure is shown in FIGS. 4A and 4B. As shown in FIGS. 4A and 4B, an exemplary embodiment of an antimicrobial film laminate assembly 50 comprises one placement strip 102 and two main strips 104 positioned upon an antimicrobial film laminate 100. In such an embodiment, for and as shown in FIG. 4B, placement strip 102 and main strips 104 are separated by cuts 108, which in at least one embodiment were made to a unitary backing 75 as shown in FIG. 1C.

In addition, and as shown in FIG. 4A, such an exemplary embodiment of an antimicrobial film laminate assembly 50 of the present disclosure comprises two tabs 110 to facilitate placement and/or alignment of antimicrobial film laminate 100 upon a targeted surface, whereby the two tabs 110 are present not at the relative ends of antimicrobial film laminate assembly 50, but somewhere in between, such as the relative middle of antimicrobial film laminate assembly 50 as shown in the exemplary embodiment shown in FIG. 4A.

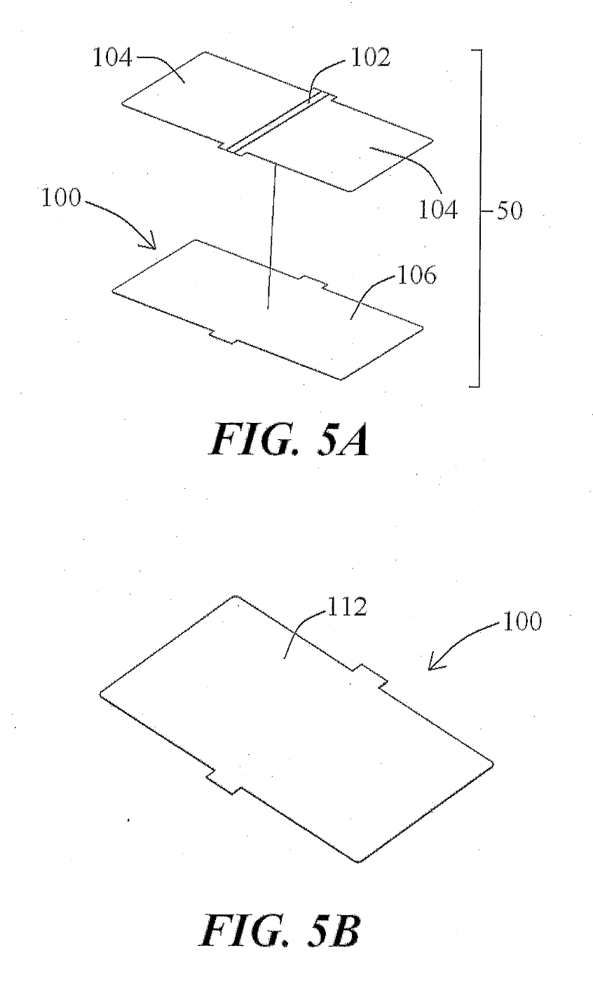

FIGS. 5A and 5B show an exemplary embodiment of an antimicrobial film laminate assembly 50 of the present disclosure with placement strip 102 and two main strips 104 removed from antimicrobial film laminate 100 and an antimicrobial surface 112 of antimicrobial film laminate 100, respectively. As shown in FIG. 5A, placement strip 102 and main strips 104 are removed from antimicrobial film laminate 100 to expose adhesive surface 106 of said laminate 100. FIG. 5B shows the opposite side of an exemplary antimicrobial film laminate 100, whereby antimicrobial surface 112 of said laminate 100 is visible in the figure. In such an embodiment, and as described in further detail herein, at least part of adhesive surface 106 would either (a) not have adhesive at one or more tabs 110, or (b) would have initially had an adhesive thereon, but that the adhesive would have either been removed or deadened at one or more tabs 110 to facilitate removal of unitary backing 75, placement strip 102, and/or main strips 104 from antimicrobial film laminate 100.

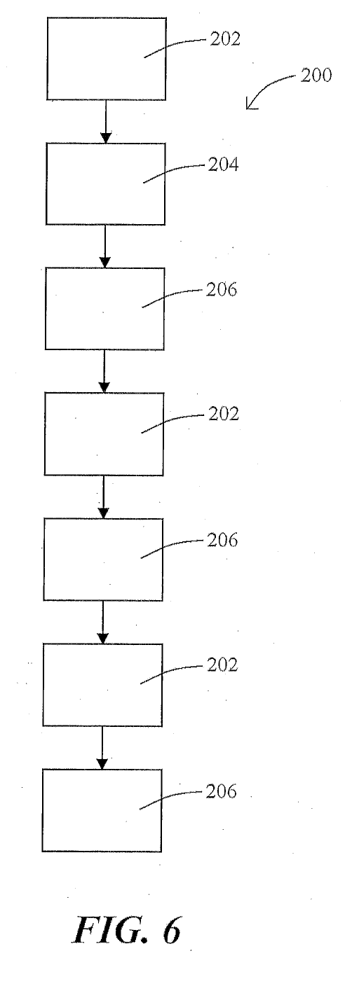

At least one embodiment of an antimicrobial film laminate 100 of an antimicrobial film laminate assembly 50 of the present disclosure, such as the exemplary embodiment shown in FIGS. 4A-5B, may be affixed to a targeted surface as shown in the method steps shown in FIG. 6. As shown in FIG. 6, an exemplary method 200 of placing an antimicrobial film laminate 100 of the present disclosure upon a targeted surface comprises the steps of removing placement strip 102 from antimicrobial film laminate 100 (an exemplary placement strip removal step 202), aligning the now-exposed adhesive surface 106 of antimicrobial film laminate 100 (which was previously covered by placement strip 102) with a targeted surface (an exemplary alignment step 204), and applying a force to the opposite side of antimicrobial film laminate 100 where adhesive surface 106 is exposed on the other side to affix antimicrobial film laminate 100 to the targeted surface (an exemplary adhesion step 206). In at least one additional method 200 of the present disclosure, and as shown in FIG. 6, method 200 may further comprise the steps of removing one of the main strips 104 from antimicrobial film laminate 100 (also an exemplary placement strip removal step 202), and applying a force to the opposite side of antimicrobial film laminate 100 where adhesive surface 106 is exposed from the removal of the first main strip 104 on the other side to affix antimicrobial film laminate 100 to the targeted surface (also an exemplary adhesion step 206). To completely affix such an embodiment of an antimicrobial film laminate 100 of the present disclosure to the targeted surface, method 200 further comprises the steps of removing the second main strip 104 from antimicrobial film laminate 100 (also an exemplary placement strip removal step 202), and applying a force to the opposite side of antimicrobial film laminate 100 where adhesive surface 106 is exposed from the removal of the second main strip 104 on the other side to affix antimicrobial film laminate 100 to the targeted surface (also an exemplary adhesion step 206).

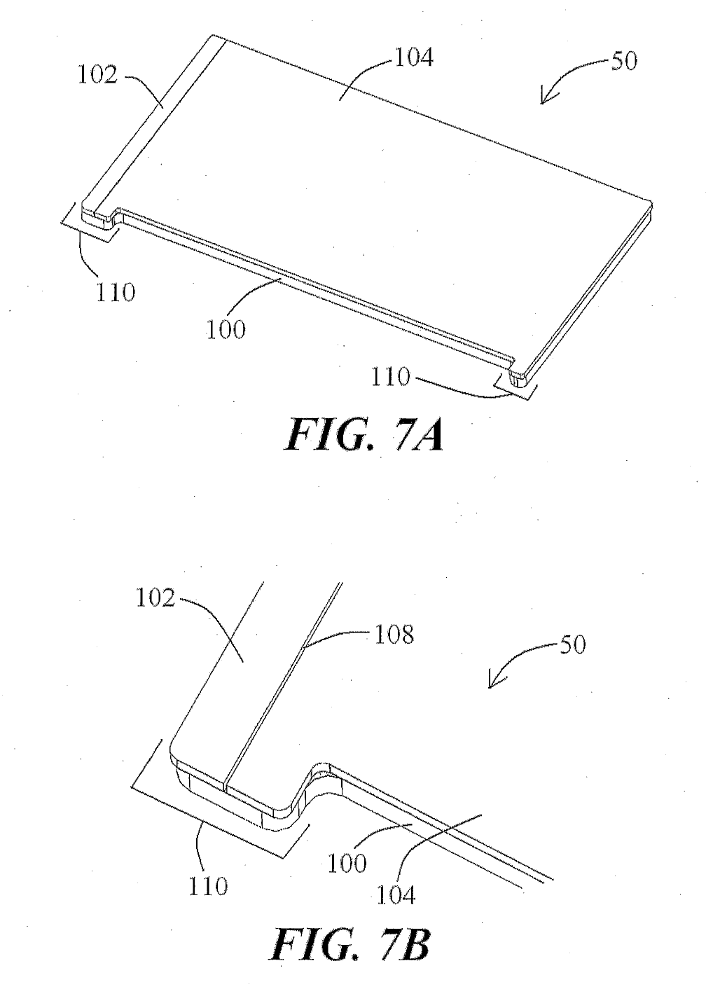

Another exemplary embodiment of an antimicrobial film laminate assembly 50 of the present disclosure is shown in FIGS. 7A and 7B. As shown in FIGS. 7A and 7B, an exemplary embodiment of an antimicrobial film laminate assembly 50 comprises an antimicrobial film laminate 100 and a placement strip 102 and a main strip 104 positioned thereon. As shown in FIG. 7A, such an exemplary embodiment of an antimicrobial film laminate assembly 50 of the present disclosure comprises two tabs 110 to facilitate placement and/or alignment of antimicrobial film laminate 100 upon a targeted surface, whereby the two tabs 110 are present at the relative opposite ends of antimicrobial film laminate assembly 50 as shown in the exemplary embodiment shown in FIG. 7A. Cut 108, separating placement strip 102 from main strip 104, may have been made to a unitary backing (not shown, but as referenced herein) to form said strips.

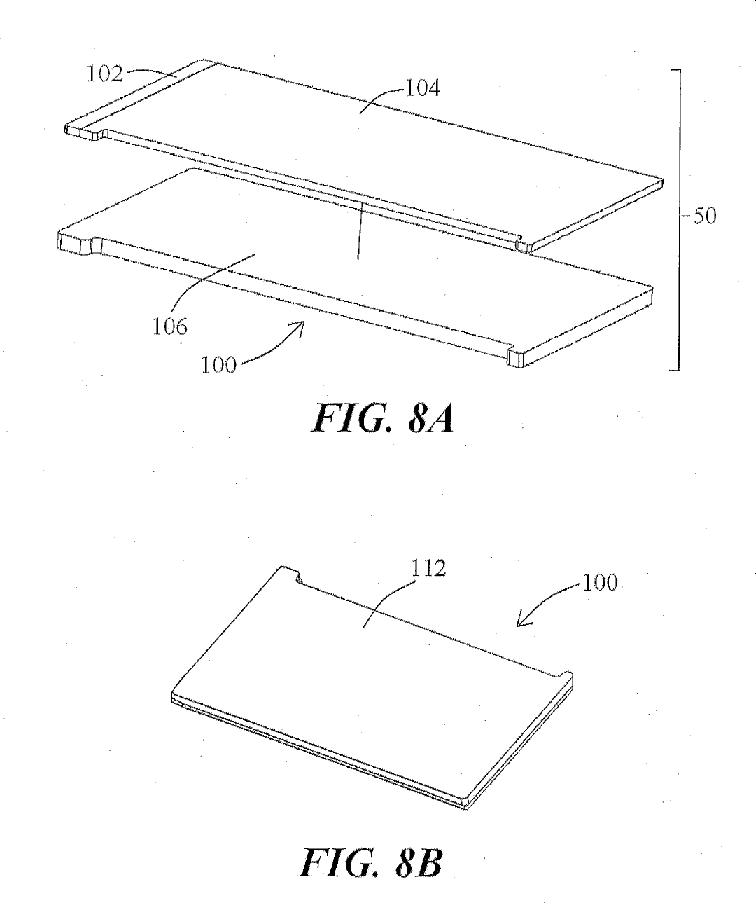

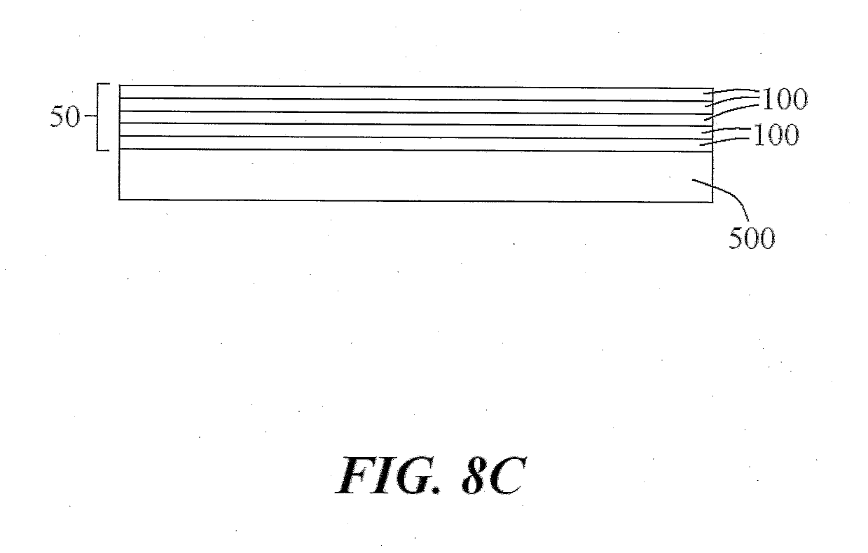

FIGS. 8A and 8B show an exemplary embodiment of an antimicrobial film laminate assembly 50 of the present disclosure with placement strip 102 and main strip 104 removed from antimicrobial film laminate 100 and an antimicrobial surface 112 of antimicrobial film laminate 100, respectively. As shown in FIG. 8A, placement strip 102 and main strip 104 are removed from antimicrobial film laminate 100 to expose adhesive surface 106 of said laminate 100. In at least one embodiment, such as the embodiment shown in FIG. 8A, at least part of adhesive surface 106 would either (a) not have adhesive at one or more tabs 110, or (b) would have initially had an adhesive thereon, but that the adhesive would have either been removed or deadened at one or more tabs 110 to facilitate removal of unitary backing 75, placement strip 102, and/or main strip 104 from antimicrobial film laminate 100.

FIG. 8B shows the opposite side of an exemplary antimicrobial film laminate 100, whereby antimicrobial surface 112 of said laminate 100 is visible in the figure. As shown in FIGS. 8A and 8B, antimicrobial film laminate 100 is relatively thicker than the exemplary embodiments of antimicrobial film laminates 100 shown in FIG. 1A and 4A. However, the relative thickness of said antimicrobial film laminates 100 may vary depending on the desired application, and antimicrobial film laminates 100 are not limited to any sort of configuration as shown in the exemplary embodiments herein.

In at least one embodiment, such as shown in FIG. 8C, an overall thickness of an antimicrobial film laminate assembly 50 may be from the layering of several antimicrobial film laminates 100 about one another and/or other targeted surfaces, so that if a first antimicrobial surface 112 is damaged, dirty, or otherwise in need of replacement, a top antimicrobial film laminate 100 may be removed to reveal a new antimicrobial film laminate 100. For example, and as shown in FIG. 8C, a plurality of antimicrobial film laminates 100 are affixed to one another upon a targeted surface 500, allowing a top antimicrobial film laminate 100 to be removed to reveal a fresh antimicrobial film laminate 100. In such an embodiment, the relative bottom antimicrobial film laminate 100 may directly affix to targeted surface 500. Such an embodiment of an antimicrobial film laminate assembly 50 positioned about a targeted surface 500, as shown in FIG. 8C, may have comprised a unitary layer 75 (not shown) positioned upon the relative “first” antimicrobial film laminate 100 prior to antimicrobial film laminate 100 being affixed to targeted surface 500.

Placement of such an embodiment of an antimicrobial film laminate 100 of the present disclosure upon a targeted surface 500, such as the embodiments shown in FIGS. 7A-8B, may be performed using the steps of method 200 shown in FIG. 3.

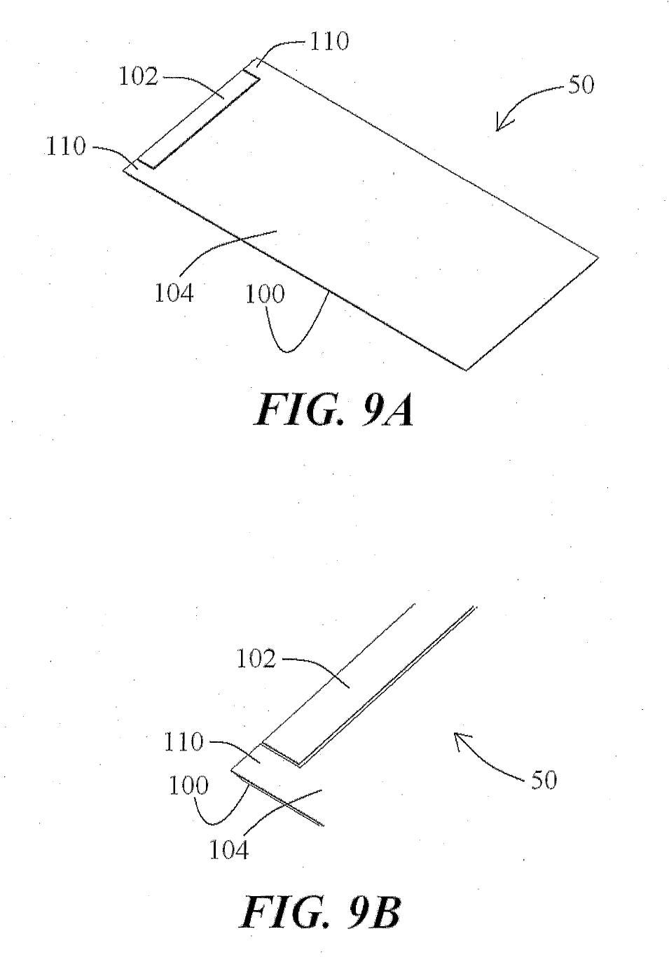

Yet another exemplary embodiment of an antimicrobial film laminate assembly 50 of the present disclosure is shown in FIGS, 9A and 9B. As shown in FIG. 9A, antimicrobial film laminate 100 of antimicrobial film laminate assembly 50 is covered with a placement strip 102 and a main strip 104, whereby placement strip 102 does not extend to the relative sides/ends of antimicrobial film laminate 100. Two tabs 110 are effectively present within such an embodiment, as the configurations of placement strip 102 and main strip 104 produce two tabs 110 of main strip 104 when placement strip 102 is removed from antimicrobial film laminate 100. In such an embodiment, and in various other embodiments of an antimicrobial film laminate assemblies 500 of the present disclosure, adhesive surface 106 may or may not contain any adhesive at or near said tabs 110, or said adhesive may have been deadened, as referenced herein and in further detail below

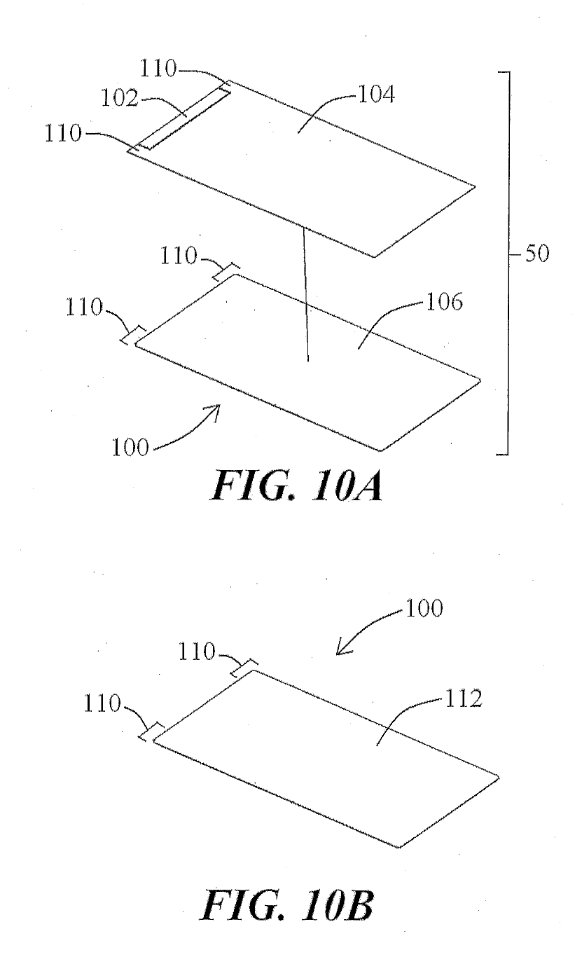

FIGS. 10A and 10B show an exemplary embodiment of an antimicrobial film laminate assembly 50 of the present disclosure with placement strip 102 and main strip 104 removed from antimicrobial film laminate 100 and an antimicrobial surface 112 of antimicrobial film laminate 100, respectively. As shown in FIG. 10A, placement strip 102 and main strip 104 are removed from antimicrobial film laminate 100 to expose adhesive surface 106 of said laminate 100, with the two effective tabs 110 (created by the relative configurations of placement strip 102 and main strip 104) indicated therein. FIG. 10B shows the opposite side of an exemplary antimicrobial film laminate 100, whereby antimicrobial surface 112 of said laminate 100 and the two effective tabs 110 shown in the figure. Placement of such an embodiment of an antimicrobial film laminate 100 of the present disclosure upon a targeted surface, such as the embodiments shown in FIGS. 9A-10B, may also be performed using the steps of method 200 shown in FIG. 3.

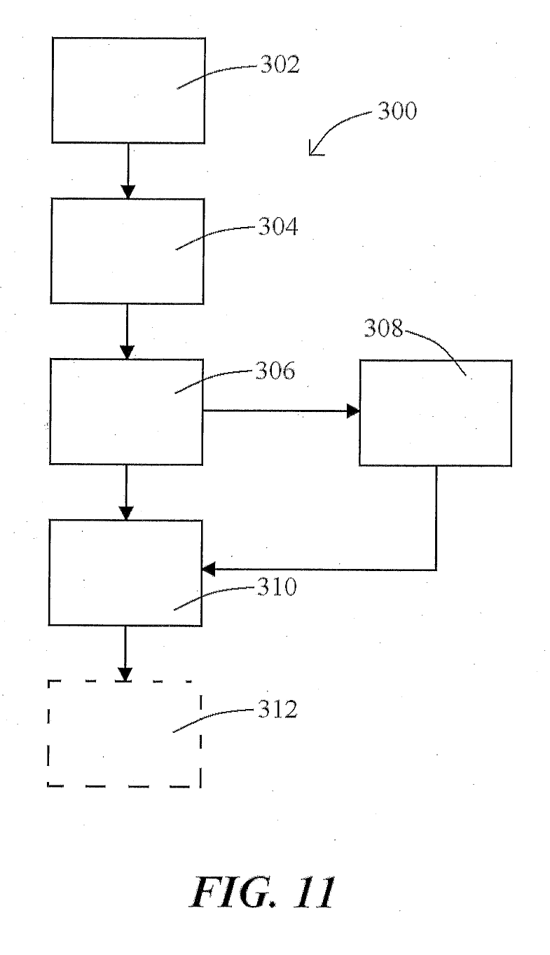

Steps of an exemplary method for manufacturing an antimicrobial film laminate assembly 50 of the present disclosure is shown in FIG. 11. As shown in FIG. 11, method 300 comprises the steps of impregnating/coating a film with an antimicrobial compound (an exemplary impregnation/coating step 302) to form an antimicrobial film laminate 100, applying an adhesive to a surface of antimicrobial film laminate 100 (an exemplary adhesive application step 304), and placing at least one backing strip (such as unitary backing 75 and/or a placement strip 102 and a main strip 104, for example) over the adhesive surface of antimicrobial film laminate 100 (an exemplary backing application step 306) to form an antimicrobial film laminate assembly 50. In an embodiment where a unitary backing 75 is placed upon antimicrobial film laminate 100, method 300 may comprise the step of cutting, such as kerf cutting or kiss cutting, unitary backing 75 to form at least one placement strip 102 and at least one main strip 104 (an exemplary backing cutting step 308).

An exemplary method 300 of the present disclosure may further comprise the step of cutting the antimicrobial film laminate assembly 50, such as by die-cutting, to form an antimicrobial film laminate assembly 50 of the present disclosure with a desired shape (an exemplary laminate cutting step 310). Laminate cutting step 310 may be performed using any number of die-cutting devices suitable for cutting laminates. Such an exemplary method 300 may further comprise the optional step of placing said antimicrobial film laminate assemblies 50 onto a roll (or in a rolled configuration) to, for example, facilitate transportation from one location to another (an exemplary rolling step 312).

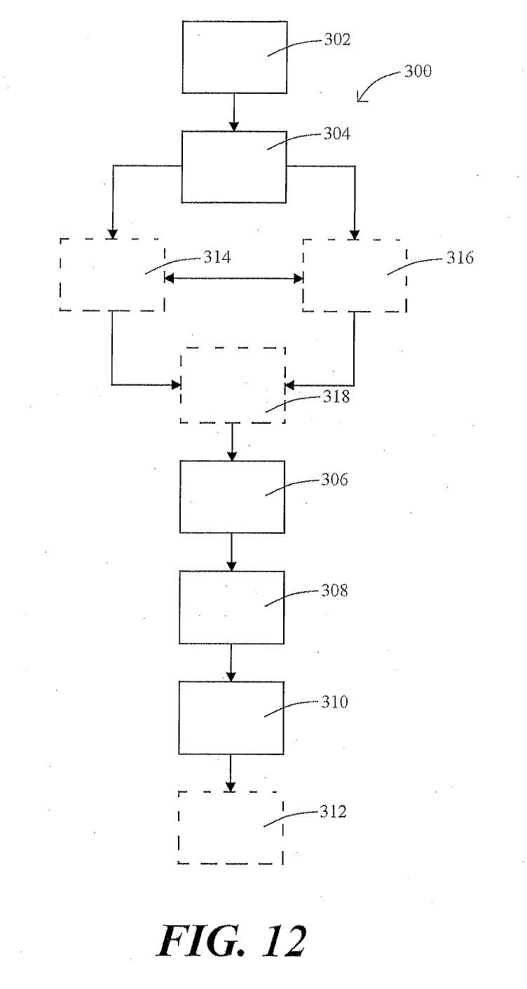

At least another exemplary embodiment of a method 300 of manufacturing an antimicrobial film laminate assembly 50 of the present disclosure is shown in FIG. 12. As shown in FIG. 12, method 300 comprises the steps of impregnating/coating a film with an antimicrobial compound (an exemplary impregnation/coating step 302) to form an antimicrobial film laminate 100, and applying an adhesive to a surface of antimicrobial film laminate 100 (an exemplary adhesive application step 304). Method 300 may then comprise the optional steps of either removing at least part of the adhesive from the surface of antimicrobial film laminate 100 (an exemplary adhesive removal step 314), and/or deadening at least part of the adhesive on the surface of antimicrobial film laminate 100 (an exemplary adhesive deadening step 316). Adhesive removal step 314 may be performed by, for example, physically removing the adhesive using a scraping device and/or one or more chemicals capable of removing adhesive, while adhesive deadening step 316 may be performed by, for example, applying ultraviolet light and/or one or more chemicals capable of deadening adhesive to the adhesive to deaden it so that it either has little or no tack as compared to adhesive which is not deadened. In another embodiment, deadening step 316 may be performed using a label press, for example, to die cut through antimicrobial film laminate 100 and either unitary backing 75, placement strip 102, and/or main strip 104, as appropriate, to create a deadened tab 110 for that section of an antimicrobial film laminate assembly 50. In yet another embodiment, deadening step 316 may be performed by delamination, whereby antimicrobial film laminate 100 is pulled off of either unitary backing 75, placement strip 102, and/or main strip 104, as appropriate, using, for example, a flexographic press, printing a deadener on the adhesive, and relaminating antimicrobial film laminate 100 to unitary backing 75, placement strip 102, and/or main strip 104. In at least one embodiment of an antimicrobial film laminate assembly 50 of the present disclosure, as referenced herein, steps, 314 and/or 316 may be performed at one or more tabs 110, so that placement of an antimicrobial film laminate 100 of an antimicrobial film laminate upon a target substrate is made easier by way of the tabs 110 either having no adhesive or deadened adhesive.

An exemplary method 300 of the present disclosure, and as shown in FIG. 12, may further comprise the optional step of applying an indicia and/or a color to at least part of antimicrobial film laminate assembly 50 (an exemplary indicia/color application step 318). In at least one embodiment, indicia/color application step 318 is performed to apply indicia and/or color to an adhesive surface 106 and/or an antimicrobial surface 112 of an antimicrobial film laminate 100, and/or is performed to apply indicia and/or color to a unitary backing 75, placement strip 102, and/or main strip 104 of antimicrobial film laminate assembly 50. In an embodiment where indicia/color application step 318 is performed to apply indicia and/or color to an adhesive surface 106 of an antimicrobial film laminate 100, steps 314 and/or 316 may be performed at a location where indicia and/or color is applied to antimicrobial film laminate 100.

In at least one embodiment, indicia/color application step 318 may be performed using flexography. Flexography is used to print, for example various types of packaging materials, such as corrugated containers, folding cartons, multiwall sacks, paper sacks, plastic bags, milk and other beverage cartons, disposable cups and containers, labels, adhesive tapes, envelopes, newspapers, and candy and food wrappers. Flexographic printing uses a printing plate made of rubber, plastic, or some other flexible material, whereby ink is applied to a raised image on the plate, which then transfers the image to the printing substrate, which may be adhesive surface 106, antimicrobial surface 112, unitary backing 75, placement strip 102, and/or main strip 104 of antimicrobial film laminate assembly 50. In at least one embodiment, the inks used are fast-drying inks, which allows for improved printing on materials such as plastics and foils. Performance of indicia/color application step 318 may also be performed using any number of other suitable printing mechanisms known in the art.

Method 300, in at least one embodiment and as shown in FIG. 12, may further comprise the steps of placing at least one backing strip (such as unitary backing 75 and/or a placement strip 102 and a main strip 104, for example) over the adhesive surface of the antimicrobial film laminate 100 (an exemplary backing application step 306), and embodiments of backing cutting step 308, laminate cutting step 310, and optionally rolling step 312.

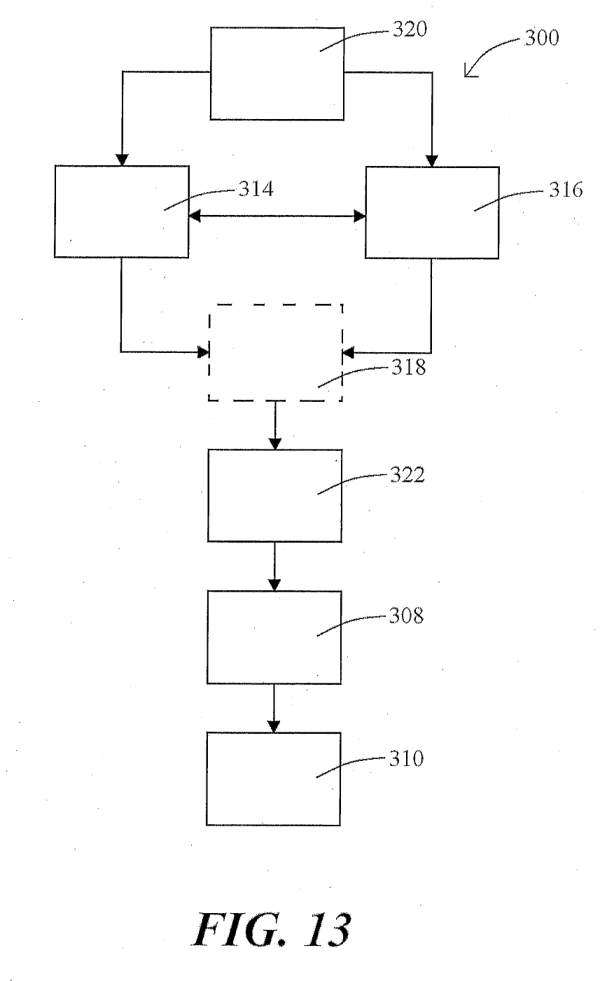

At least another exemplary embodiment of a method 300 of manufacturing an antimicrobial film laminate assembly 50 of the present disclosure is shown in FIG. 13. As shown in FIG. 13, method 300 comprises the steps of delaminating an antimicrobial film laminate assembly 50 by removing unitary backing 75, for example, from antimicrobial film laminate 100 (an exemplary delamination step 320), and either removing at least part of the adhesive from the surface of antimicrobial film laminate 100 (an exemplary adhesive removal step 314), and/or deadening at least part of the adhesive on the surface of the antimicrobial film laminate 100 (an exemplary adhesive deadening step 316). Steps 314 and/or 316 may be performed to remove/deaden adhesive at one or more tabs 110, and/or may be performed to remove/deaden adhesive at a location upon antimicrobial film laminate 100 to receive indicia and/or color.

Method 300, in at least one embodiment, may then comprise the optional step of applying an indicia and/or a color to at least part of antimicrobial film laminate 100 (an exemplary indicia/color application step 318). An exemplary method 300 may then comprise the steps of relaminating antimicrobial film laminate 100 to, for example, reapply unitary backing 75 (an exemplary relamination step 322) to form an antimicrobial film laminate assembly 50, cutting unitary backing 75 to form at least one placement strip 102 and at least one main strip 104 (an exemplary backing cutting step 308), and cutting antimicrobial film laminate assembly 50, such as by die-cutting, to form an antimicrobial film laminate assembly 50 of the present disclosure with a desired shape (an exemplary laminate cutting step 310).

In at least one embodiment of an antimicrobial film laminate assembly 50 of the present disclosure, an antimicrobial film laminate 100 of antimicrobial film laminate assembly 50 may be affixed to a targeted surface by way of static cling. Furthermore, and in various embodiments of antimicrobial film laminate assemblies 50 of the present disclosure, antimicrobial film laminates 100 may comprise one, two, three, or more placement strips 102 and/or main strips 104. Furthermore, and in various embodiments, antimicrobial film laminate assemblies 50 may comprise one, two, three, or more tabs 110 positioned at various places about antimicrobial film laminate 100.

While various embodiments of antimicrobial film laminate assemblies and methods for using and manufacturing the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. An antimicrobial film laminate assembly, the assembly comprising:
an antimicrobial film laminate having a first surface at least partially coated with an adhesive and an opposing second surface, said antimicrobial film laminate comprising at least one antimicrobial compound; and
a unitary backing positioned upon the first surface of the antimicrobial film laminate.

2. The antimicrobial film laminate assembly of claim 1, wherein the antimicrobial film laminate assembly comprises at least one tab.

3. The antimicrobial film laminate assembly of claim 2, wherein the unitary backing is cut to form at least one placement strip and at least one main strip, and wherein the at least one tab is positioned at the at least one placement strip.

4. The antimicrobial film laminate assembly of claim 2, wherein the at least one tab comprises two tabs.

5. The antimicrobial film laminate assembly of claim 4, wherein the two tabs are configured about the antimicrobial film laminate assembly at or near relative ends of the antimicrobial film laminate assembly.

6. The antimicrobial film laminate assembly of claim 4, wherein the two tabs are configured about the antimicrobial film laminate assembly at or near the relative middle of the antimicrobial film laminate assembly.

7. The antimicrobial film laminate assembly of claim 2, wherein the adhesive is deadened at the at least one tab.

8. The antimicrobial film laminate assembly of claim 2, wherein no adhesive is present upon the first surface at the at least one tab.

9. The antimicrobial film laminate assembly of claim 1, wherein the unitary backing is cut to form at least one placement strip and at least one main strip.

10. The antimicrobial film laminate assembly of claim 1, wherein the adhesive is capable of causing the antimicrobial film laminate to either permanently or removably adhere to one or more targeted surfaces.

11. The antimicrobial film laminate assembly of claim 1, wherein the at least one antimicrobial compound comprises a silver ion antimicrobial compound.

12. The antimicrobial film laminate assembly of claim 1, wherein the antimicrobial film laminate is placed onto a roll or is rolled into a rolled configuration.

13. The antimicrobial film laminate assembly of claim 1, wherein at least part of the antimicrobial film laminate assembly has indicia and/or a color imprinted thereon.

14. The antimicrobial film laminate assembly of claim 1, wherein the antimicrobial film laminate is made from a material selected from the group consisting of polyethylene terephthalate, polypropylene, high impact polystyrene, polyvinyl chloride, and paper.

15. The antimicrobial film laminate assembly of claim 1, wherein the antimicrobial film laminate is selected from the group consisting of a transparent antimicrobial film laminate, a translucent antimicrobial film laminate, and an opaque antimicrobial film laminate.

16. A method for affixing an antimicrobial film laminate to a targeted surface, the method comprising the steps of:
removing a placement strip from an antimicrobial film laminate to expose an adhesive surface;
aligning the antimicrobial film laminate with a targeted surface;
applying a force to an opposite side of the antimicrobial film laminate so that the adhesive surface of the antimicrobial film laminate is affixed to the targeted surface where the placement strip has been removed;
removing a first main strip from the antimicrobial film laminate to expose more adhesive surface; and
applying a force to an opposite side of the antimicrobial film laminate so that the adhesive surface of the antimicrobial film laminate where the first main strip has been removed is affixed to the targeted surface.

17. The method of claim 16, further comprising the step of:
repeating each aforementioned step with a second antimicrobial film laminate, wherein the second antimicrobial film laminate is affixed upon the original antimicrobial film laminate.

18. A method for manufacturing an antimicrobial film laminate assembly, the method comprising the steps of:
impregnating and/or coating a laminate with an antimicrobial compound;
applying an adhesive to a first surface of the laminate; and either
(a) removing at least part of the adhesive from the first surface of the laminate; or
(b) deadening at least part of the adhesive from the first surface of the laminate.

19. The method of claim 18, wherein the method comprises the step of removing at least part of the adhesive, and wherein said step is performed by removing the adhesive using one or more chemicals capable of removing adhesive.

20. The method of claim 18, wherein the method comprises the step of deadening at least part of the adhesive, and wherein said step is performed by deadening the adhesive using one or more chemicals capable of deadening adhesive to minimize or eliminate adhesive tack.
